(19) United States
(12) Patent Application Publication
(10) Pub. No.: US 2026/0307804 A1
(43) Pub. Date: Oct. 8, 2026

(54) Monument Tray Table Rotatable Shelf

(71) Applicant: B/E Aerospace, Inc., Winston Salem, NC (US)

(72) Inventors: Christopher D. Adcock, Advance, NC (US); Travis K. Finlay, Durham, NC (US)

(73) Assignee: B/E Aerospace, Inc., Winston Salem, NC (US)

(21) Appl. No.: 19/636,642

(22) Filed: Apr. 1, 2026

Related U.S. Application Data
(60) Provisional application No. 63/783,437, filed on Apr. 4, 2025.

(51) Int. Cl. B64D 11/06; A47B 5/00; A47B 5/04; B64D 11/00

(52) U.S. Cl. CPC B64D 11/0638; A47B 5/006; A47B 5/04; B64D 11/0015

(57) ABSTRACT

An aircraft monument may comprise a vertical pocket for retaining a tray table. An extendible arm of the tray table may rotate about a first axis to extend the tray table from the vertical pocket. A rotatable shelf coupled to the extendible arm may rotate between a horizontal position, a vertical position, and an obtuse position. An electronic device holder may be disposed on a bottom side of the rotatable shelf. When the rotatable shelf is in the vertical position or in the obtuse position, the electronic device holder may rotate from the bottom side to an open position.

### CROSS REFERENCE TO RELATED APPLICATIONS

This application claims the benefit of and priority to U.S. Provisional Application No. 63/783,437, entitled “MONUMENT TRAY TABLE ROTATABLE SHELF,” filed on Apr. 4, 2025, which is hereby incorporated by reference in its entirety for all purposes.

### TECHNICAL FIELD

The present disclosure relates generally to a tray table and, more particularly, to a rotatable tray table with an electronic device holder for portable electronics holders.

### BACKGROUND

Aircraft passengers are increasingly using personal electronic devices in aircraft seats. Hands-free shelves for portable electronic devices (PED) are typically disposed on the back of aircraft seats or on a top side of a tray table deployable from an aircraft seat. Top-side trays are exposed to debris such as crumbs or spills. Wheelchair plinths are typically disposed facing open spaces, such as an aisle, and are typically not aft of a seat or a wall. Trays deployed from the back of aircraft seats may not be compatible with wheelchair plinths.

### SUMMARY

In one aspect, a tray table system is disclosed. The tray table system may comprise an extendible arm, a rotatable shelf rotatably coupled to the extendible arm, and an electronic device holder rotatably coupled to a bottom side of the rotatable shelf.

In various embodiments, the tray table system may further comprise a main hinge about which the rotatable shelf is configured to rotate with respect to the extendible arm.

In various embodiments, the main hinge may comprise a friction device configured to resist rotation of the rotatable shelf about the main hinge.

In various embodiments, the friction device may comprise an O-ring.

In various embodiments, the tray table system may further comprise a mechanical latch configured to secure the electronic device holder within a cavity of the rotatable shelf when the electronic device holder is in a closed position.

In various embodiments, the tray table system may further comprise a first magnet disposed within the rotatable shelf and a second magnet disposed within the electronic device holder. In various embodiments, the first magnet and the second magnet may be of opposite polarization.

In various embodiments, the main hinge may be configured to allow the rotatable shelf to rotate between 90 degrees and 180 degrees about the extendible arm.

In another aspect, an aircraft monument is disclosed. The aircraft monument may comprise a tray table having an extendible arm configured to rotate about a first axis to extend from the aircraft monument, a rotatable shelf coupled to the extendible arm and configured to rotate about a second axis perpendicular to the first axis, and an electronic device holder rotatably coupled to a bottom side of the rotatable shelf.

In various embodiments, the aircraft monument may further comprise a vertical pocket configured to retain the tray table when the tray table is in a stowed position.

In various embodiments, the tray table may comprise a main hinge about which the rotatable shelf is configured to rotate with respect to the extendible arm and a secondary hinge about which the electronic device holder is configured to rotate with respect to the rotatable shelf.

In various embodiments, each of the main hinge and the secondary hinge may be configured to accommodate between 90 degrees and 180 degrees of rotation.

In various embodiments, in response to the extendible arm extending from the aircraft monument, the rotatable shelf may be configured to rotate between a horizontal position, a vertical position, and an obtuse position, and the electronic device holder may be configured to independently rotate between an open position and a closed position.

In various embodiments, in response to the rotatable shelf being in the obtuse position and the electronic device holder being in the open position, the tray table may be configured to receive a portable electronic device such that the portable electronic device is resting on the electronic device holder and against the rotatable shelf at an incline.

In various embodiments, a bottom side of the rotatable shelf may define a cavity for receiving the electronic device holder.

In various embodiments, the aircraft monument may further comprise a mechanical latch configured to secure the electronic device holder within the cavity such that the electronic device holder is flush with the bottom side of the rotatable shelf.

In various embodiments, the aircraft monument may further comprise a first magnet disposed within the cavity and a second magnet disposed within the electronic device holder. In various embodiments, the first magnet and the second magnet are of opposite polarization such that the second magnet is attracted to the first magnet.

In various embodiments, the main hinge may comprise a friction device configured to resist rotation of the rotatable shelf.

In another aspect, an aircraft is disclosed. The aircraft may comprise a wheelchair plinth, an aircraft monument disposed proximate the wheelchair plinth, and a tray table extendible from the aircraft monument toward the wheelchair plinth.

In various embodiments, the tray table may comprise an extendible arm configured to rotate about a first axis to extend from the aircraft monument, a rotatable shelf coupled to the extendible arm and configured to rotate about a second axis perpendicular to the first axis, and an electronic device holder rotatably coupled to a bottom side of the rotatable shelf.

In various embodiments, the tray table may comprise a main hinge about which the rotatable shelf is configured to rotate with respect to the extendible arm and a secondary hinge about which the electronic device holder is configured to rotate with respect to the rotatable shelf, and each of the main hinge and the secondary hinge may be configured to accommodate between 90 degrees and 180 degrees of rotation.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan with a wheelchair plinth, in accordance with various embodiments;

FIG. 3 illustrates a tray table in a stowed position, in accordance with various embodiments;

FIG. 4 illustrates a tray table, in accordance with various embodiments;

FIG. 5 illustrates a tray table in a first deployed position, in accordance with various embodiments;

FIG. 6 illustrates a tray table in a second deployed position, in accordance with various embodiments;

FIG. 7 illustrates a tray table in a second deployed position, in accordance with various embodiments;

FIG. 8 illustrates a tray table in a third deployed position, in accordance with various embodiments;

FIG. 9 illustrates a tray table, in accordance with various embodiments;

FIG. 10 illustrates a tray table, in accordance with various embodiments;

FIG. 11A illustrates a friction device, in accordance with various embodiments; and

FIG. 11B illustrates a friction device, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Aircraft passengers are increasingly using personal electronic devices in aircraft seats. It is desirable to have a hands-free, approximately eye-level shelf or perch for such devices that secures the device while positioning the device at an ideal angle for comfortable viewing. However, typical electronic device holders or shelves are disposed within seat backs. Such an arrangement limits deployment of electronic device holders or shelves for passengers seated near monuments. Accordingly, improved electronic device holders or shelves for deployment from aircraft monuments are desirable.

In various embodiments, the present disclosure provides for an electronic device holder deployable from an aircraft monument. The electronic device holder may be a shelf in an airplane tray table designed to hold personal electronic devices (PEDs) such as smartphones, tablets, or e-readers securely during the flight.

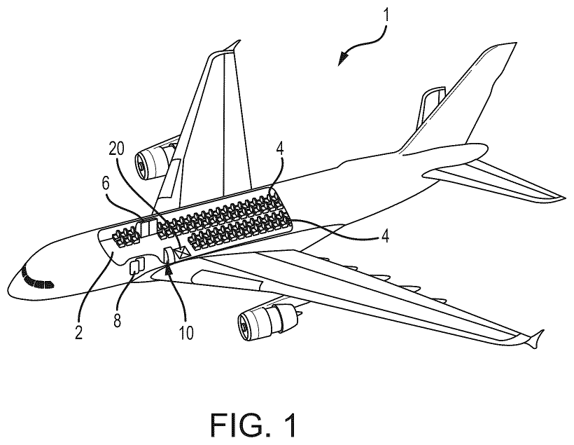

With initial reference to FIG. 1, an aircraft 1 is illustrated, in accordance with various embodiments. Aircraft 1 may comprise an aisle 2. Aircraft 1 may comprise a plurality of seats 4. Aircraft 1 may comprise one or more lavatories 6. Aircraft 1 may comprise a door 8. Aircraft 1 may comprise a monument 10. Aircraft 1 may comprise a wheelchair plinth 20. Wheelchair plinth 20 may be disposed proximate door 8. Wheelchair plinth 20 may be disposed proximate monument 10.

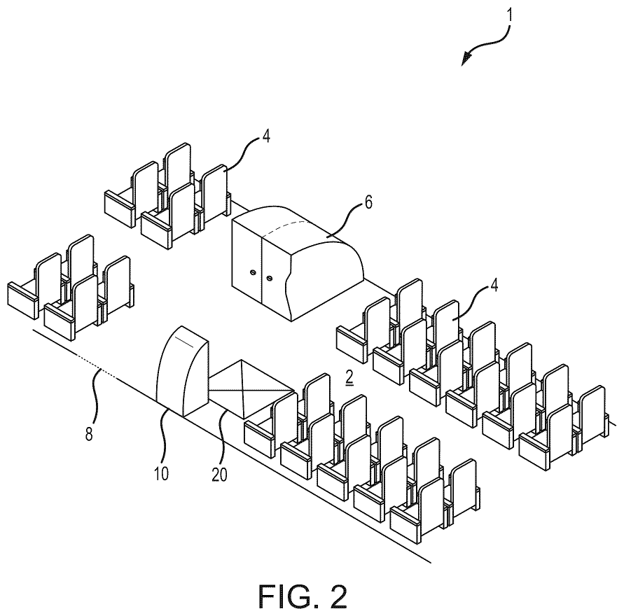

With initial reference to FIG. 2, a floor plan of aircraft 1 is illustrated, in accordance with various embodiments. As illustrated, wheelchair plinth 20 and monument 10 are disposed aft of door 8. However, it should be understood that wheelchair plinth and/or monument 10 may be disposed at any location within aircraft 1. As illustrated, monument 10 is disposed outboard of wheelchair plinth 20 and face inboard toward aisle 2. However, it should be understood that monument 10 may be disposed inboard of wheelchair plinth 20 and face outboard toward wheelchair plinth 20.

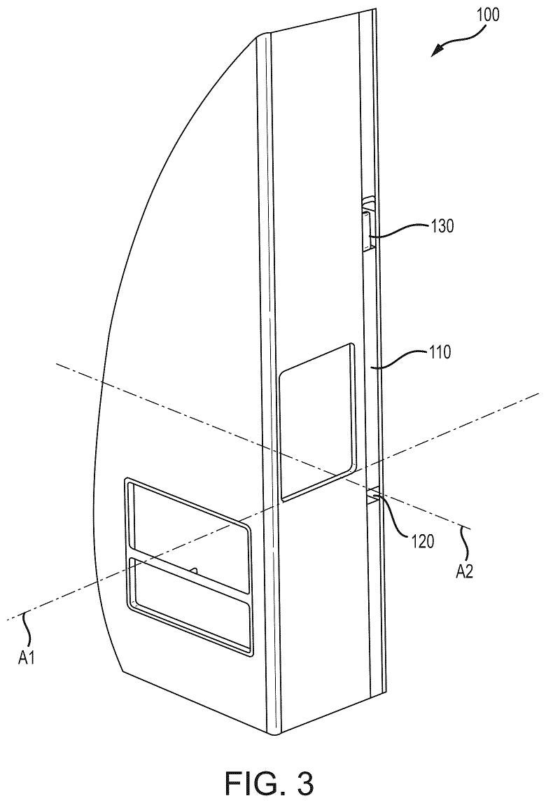

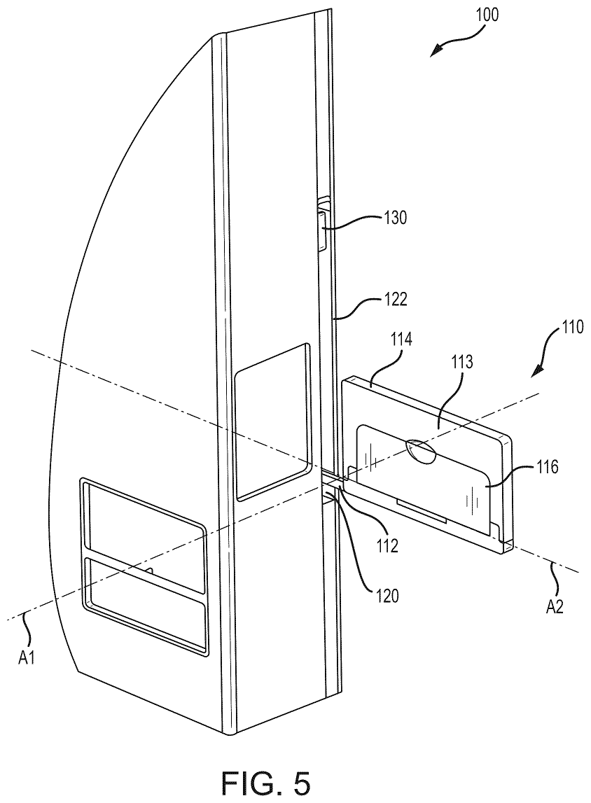

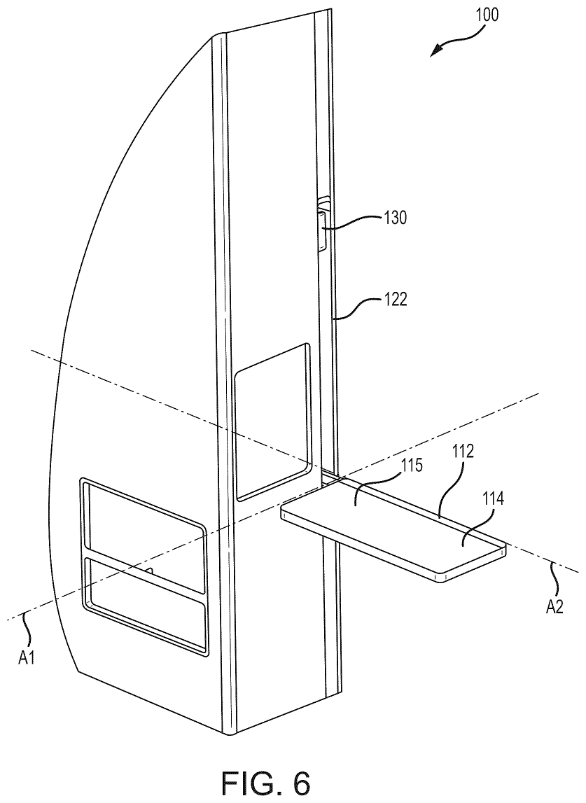

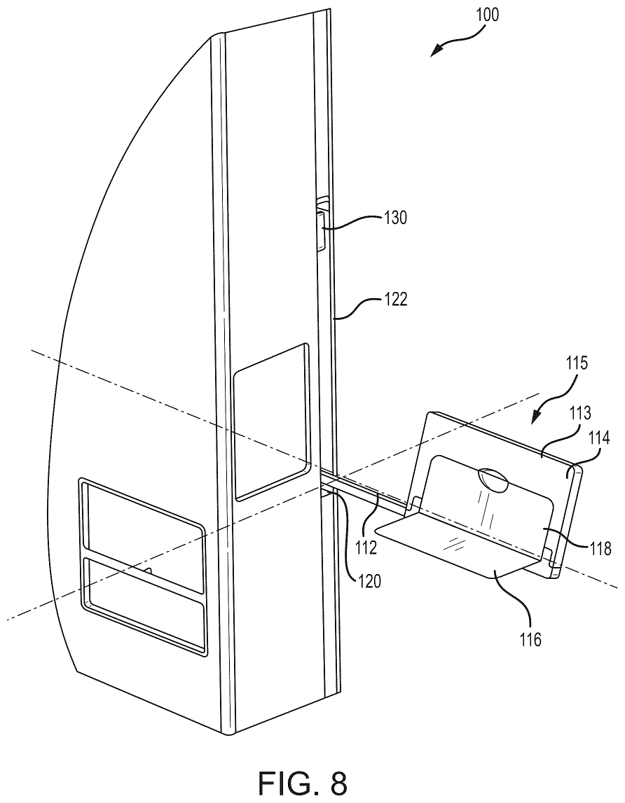

With reference to FIGS. 3-8, a monument 100 is illustrated. Monument 100 may be an aircraft monument similar to monument 10. Monument 100 may comprise a tray table 110. Tray table 110 may stowable within monument 100. Monument 100 may comprise a latch 130 for retaining the tray table 110 in a stowed position, as illustrated in FIG. 3. Monument 100 may comprise a first hinge 120 about which tray table 110 may rotate. As best illustrated in FIGS. 5 and 6, tray table 110 may comprise a rotatable shelf 114 and an extendible arm 112. Rotatable shelf 114 may be disposed on an end of extendible arm 112. As best illustrated in FIG. 8, tray table 110 may comprise an electronic device holder 116 disposed on a bottom side 113 of a rotatable shelf 114.

In various embodiments, the electronic device holder 116 may provide for optimal viewing angles of a received PED. The electronic device holder 116 may provide for hands-free operation or viewing of a received PED. In various embodiments, the electronic device holder 116 may be a dropdown shelf extending from the bottom side 113 of the rotatable shelf 114. The electronic device holder 116 is versatile in that it may be compatible with state-of-the-art electronics as well as backward compatible with older technologies.

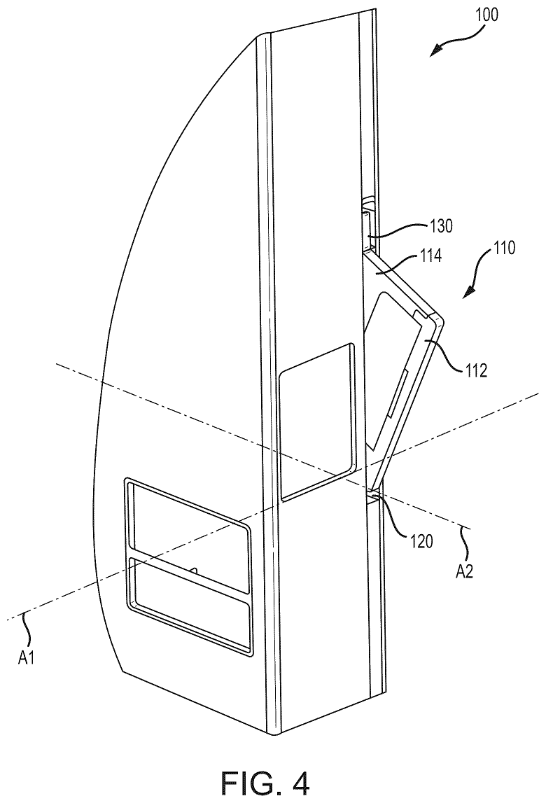

As shown in FIG. 4, tray table 110 may rotate about a first axis A1 defined by the first hinge 120 to extend from monument 100. In various embodiments, the extendible arm 112 of tray table 110 may rotate about the first axis A1 to extend the rotatable shelf 114 from monument 100. Tray table 110 and/or extendible arm 112 may be free to rotate about the first axis A1 in response to latch 130 being released.

As shown in FIG. 5, tray table 110 is illustrated in a first deployed position. In the first deployed position, the tray table 110 may be rotated from monument 100 until the extendible arm 112 is in a horizontal position. In various embodiments, tray table 110 may be rotated from monument 100 until the extendible arm 112 is in a parallel to the aisle 2 of aircraft 1 (and/or perpendicular to the monument 100). When tray table 110 is rotated from monument 100 (or when prepared to be rotated into the monument 100), the extendible arm 112 is in a collapsed position and the rotatable shelf 114 is in a vertical position. When in the collapsed position, the extendible arm 112 is shortened such that the rotatable shelf 114 is disposed proximate the monument. When the extendible arm 112 is in the collapsed position, the tray table 110 is shortened such that the tray table 110 may be rotated into a vertical pocket 122 of the monument 100 and into the stowed position. When rotated into the vertical pocket 122, tray table 110 may be configured to be discreetly retained within the vertical pocket 122 such that the tray table 110 does not extend beyond a profile of the monument 100. In other words, in the stowed position, the tray table 110 is fully retained within the monument 100.

As depicted in FIG. 5, the electronic device holder 116 is in a closed position in which the electronic device holder 116 is retracted into the bottom side 113 of the rotatable shelf 114. However, it should be understood that the electronic device holder 116 may be rotated to an open position, as described further herein. In the open position, the electronic device holder 116 may be generally perpendicular to the bottom side 113 of the rotatable shelf 114. In the open position, the electronic device holder 116 may be disposed at an obtuse angle to the bottom side 113 of the rotatable shelf 114. In the open position, the electronic device holder 116 may be rotated between 90 and 180 degrees from the bottom side 113 of the rotatable shelf 114. In the open position, the electronic device holder 116 may be rotated between 90 and 135 degrees from the bottom side 113 of the rotatable shelf 114.

As shown in FIG. 6, tray table 110 is illustrated in a second deployed position with the extendible arm 112 is in a collapsed position and the rotatable shelf 114 is in a horizontal position. Tray table 110 may rotate about a second axis A2 defined by a main hinge, described in more detail below, between a horizontal position (shown in FIG. 6), a vertical position (shown in FIG. 5), and an obtuse position (shown in FIG. 8). Second axis A2 may be perpendicular to first axis A1. The tray table 110 may be parallel to the floor of the aisle 2. In this manner, the tray table 110 may be used as a surface by a crewmember and/or a passenger seated in the wheelchair plinth 20.

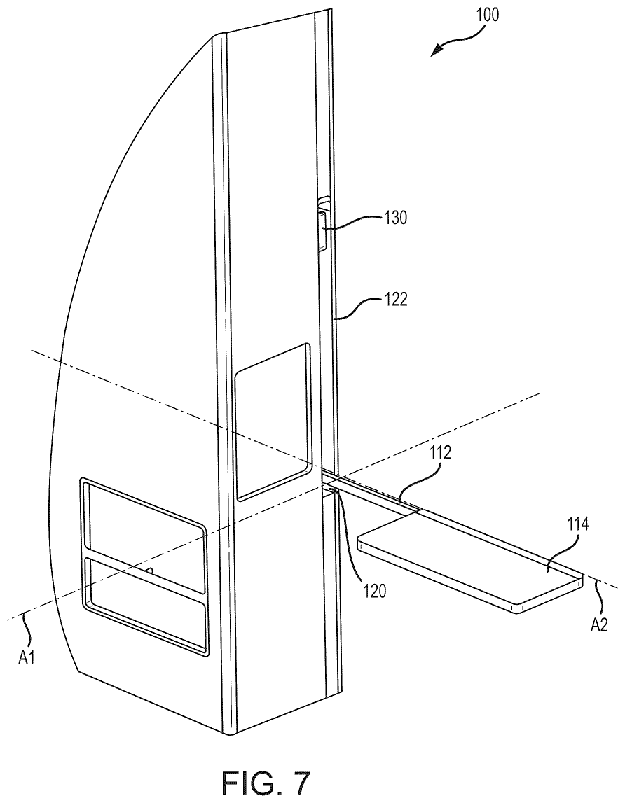

As shown in FIG. 7, tray table 110 is illustrated in a second deployed position with the extendible arm 112 is in an extended position and the rotatable shelf 114 is in a horizontal position. In various embodiments, the extendible arm 112 may extend between discrete positions along the length of the extendible arm 112. In various embodiments, the extendible arm 112 may extend continuously along the length of the extendible arm 112. In this manner, the extendible arm 112 may be adjusted to a position of a passenger seated in the wheelchair plinth 20.

As shown in FIG. 8, tray table 110 is illustrated in a third deployed position in which the rotatable shelf 114 is rotated to a vertical position and the electronic device holder 116 is in an open position. In various embodiments, the rotatable shelf 114 is rotated past a vertical position to an obtuse position and the electronic device holder 116 is in an open position. In various embodiments, in the obtuse position, the rotatable shelf 114 may be at an obtuse angle with respect to the electronic device holder 116. In the third deployed position, rotatable shelf 114 may be rotated from the second deployed position between 90 and 180 about the extendible arm. In the third deployed position, rotatable shelf 114 may be rotated from the second deployed position between 90 and 135 about the extendible arm.

In various embodiments, the electronic device holder 116 may be rotated from a cavity 118 of the tray table 110. When the electronic device holder 116 is in the closed position, the underside of the electronic device holder 116 may be flush with the bottom side 113 of the rotatable shelf 114. When the electronic device holder 116 is in the open position, the cavity 118 and/or the bottom side 113 or the rotatable shelf 114 may serve as a backrest for a PED. As such, a PED resting on the open electronic device holder 116 may be inclined toward a passenger's line of sight. The PED may be inclined so as to rest against the cavity 118 and/or the bottom side 113 or the rotatable shelf 114 so as to allow for handsfree use of the PED.

While the extendible arm 112 is, for illustration purposes, shown in the extended position, it should be understood that, in various embodiments, the rotatable shelf 114 may be rotated past the vertical position and the electronic device holder 116 may be in an open position while the extendible arm 112 is in the collapsed position.

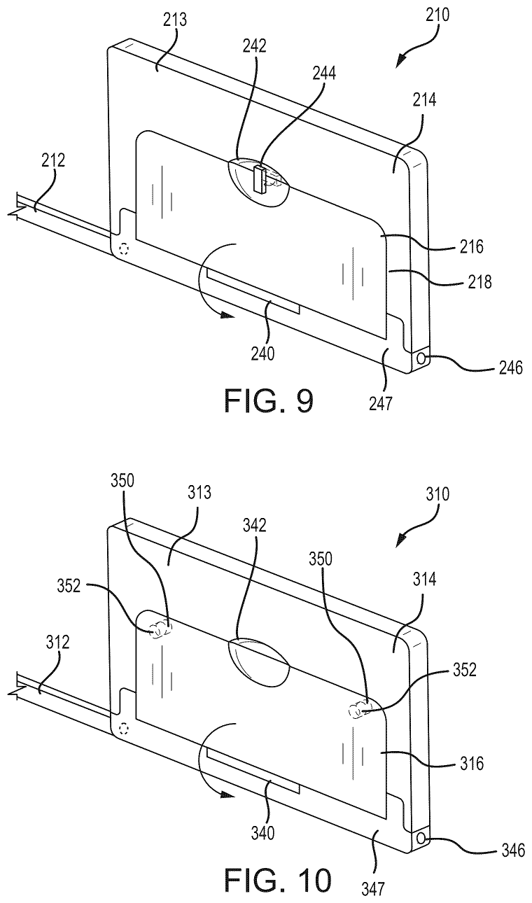

With respect to FIG. 9, a tray table 210 is illustrated. Tray table 210 may be similar to tray table 110 and configured to extend from monument 100 such that like numbering represents like features. Tray table 210 may comprise a rotatable shelf 214 coupled to an extendible arm 212. In various embodiments, the rotatable shelf 214 may comprise a main hinge 247 about which the rotatable shelf 214 rotates with respect to the extendible arm 212. In various embodiments, the main hinge 247 may comprise a friction device 246. The friction device 246 may be configured to resist rotational slippage of the main hinge 247. The friction device 246 may be configured to prevent the rotatable shelf 214 from freely falling from the vertical position to the horizontal position. The friction device 246 may be configured to prevent the rotatable shelf 214 from over-rotating when rotated to the obtuse position. The friction device 246 may be an O-ring, a spring, or any other device for adding resistance to main hinge 247.

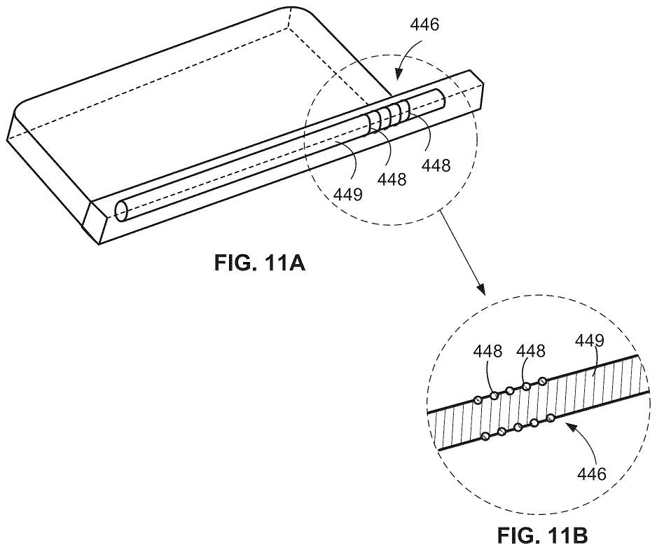

With additional brief reference to FIGS. 11A and 11B, and in various embodiments, a friction device 446 is illustrated. The friction device 446 may be an example of friction devices 246, 346 and compatible with tray tables 110, 210, 310. Friction device 446 may comprise a bar 449 extending through tray table 110, 210, 310. The bar 449 may be fixed as rotatable shelf 114. 214, 314 rotates around bar 449. One or more O-rings 448 may create a friction force between the rotatable shelf 114, 214, 314 and the bar 449 as rotatable shelf 114, 214, 314 rotates.

In various embodiments, the friction device 246, 346, 446 may comprise alternative friction mechanisms including, but not limited to, friction washers, brake pads, clutch mechanisms, detent systems, wave springs, Belleville washers, or combinations thereof. The friction device 246, 346, 446 may comprise an adjustable friction mechanism configured to allow adjustment the resistance of the main hinge 247, 347 to a desired level. In various embodiments, the friction device 246, 346, 446 may be configured to provide a torque resistance sufficient to maintain the rotatable shelf 214, 314 in a desired position under the weight of a portable electronic device.

In various embodiments, the friction device 246, 346, 446 may be formed from one or more materials selected from elastomeric materials, polymeric materials, metallic materials, composite materials, or combinations thereof. Suitable elastomeric materials may include natural rubber, synthetic rubber, silicone rubber, nitrile rubber, EPDM (ethylene propylene diene monomer), neoprene, or fluoroelastomers. Suitable polymeric materials may include polytetrafluoroethylene (PTFE), polyoxymethylene (POM), polyamide (nylon), polyethylene, polypropylene, or polyetheretherketone (PEEK). Suitable metallic materials may include steel, stainless steel, aluminum, brass, bronze, or copper alloys. In various embodiments, the friction device 246, 346, 446 may comprise a combination of materials, such as a metallic component with an elastomeric coating or insert.

In various embodiments, electronic device holder 216 may be secured within the cavity 218 of tray table 210 with a tray latch 244. Tray latch 244 may be rotated from a pivot point in an upper portion 242 of the cavity 218 to secure the electronic device holder 216 in the closed position. When in the closed position, the electronic device holder 216 may be flush with the bottom side 213 of the rotatable shelf 214. The tray latch 244 may be rotated to release the electronic device holder 216 to rotate about secondary hinge 240 to the open position.

With respect to FIG. 10, a tray table 310 is illustrated. Tray table 310 may be similar to tray tables 110, 210 and configured to extend from monument 100 such that like numbering represents like features. Tray table 310 may comprise a rotatable shelf 314 coupled to an extendible arm 312. Rotatable shelf 314 may be rotatable about main hinge 347, which may comprise a friction device 346 similar to friction device 246. The tray table 310 may comprise an electronic device holder 316 rotatable about a secondary hinge 340. The electronic device holder 316 may be secured within a cavity 318 of rotatable shelf 314 when the electronic device holder 316 is in a closed position. In the closed position, the electronic device holder 316 may be flush with the bottom side 313 of the rotatable shelf 314.

In various embodiments, electronic device holder 316 may be magnetically secured within the cavity 318 of tray table 310 when in the closed position. A first magnet 350 may be disposed within the cavity 318. A second magnet 352 may be disposed within the electronic device holder 316. The first magnet 350 and the second magnet 352 may be oppositely polarized such that the second magnet 352 is attracted to the first magnet 350. As the electronic device holder 316 is rotated from the open position to the closed position, the attraction of the second magnet 352 to the first magnet 350 may retain the electronic device holder 316 in the closed position. In various embodiments, the cavity 318 may comprise a plurality of first magnets 350 and the electronic device holder may comprise a plurality of second magnets 352.

Finally, it should be noted that while this disclosure is directed primarily to a tray table deployed from an aircraft monument, that the concepts described above can also be applied to tray tables deployed from alternate structures or at alternate angles. For example, tray tables 110, 210, 310 may be configured to extend from an alternative structure such as a galley, seats, etc.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A tray table system, comprising:
an extendible arm;
a rotatable shelf rotatably coupled to the extendible arm; and
an electronic device holder rotatably coupled to a bottom side of the rotatable shelf.

2. The tray table system of claim 1, further comprising a main hinge about which the rotatable shelf is configured to rotate with respect to the extendible arm.

3. The tray table system of claim 2, wherein the main hinge comprises a friction device configured to resist rotation of the rotatable shelf about the main hinge.

4. The tray table system of claim 3, wherein the friction device is an O-ring.

5. The tray table system of claim 1, further comprising a mechanical latch configured to secure the electronic device holder within a cavity of the rotatable shelf when the electronic device holder is in a closed position.

6. The tray table system of claim 1, further comprising a first magnet disposed within the rotatable shelf and a second magnet disposed within the electronic device holder, wherein the first magnet and the second magnet are of opposite polarization.

7. The tray table system of claim 2, wherein the main hinge is configured to allow the rotatable shelf to rotate between 90 degrees and 180 degrees about the extendible arm.

8. An aircraft monument, comprising:
a tray table having an extendible arm configured to rotate about a first axis to extend from the aircraft monument, a rotatable shelf coupled to the extendible arm and configured to rotate about a second axis perpendicular to the first axis, and an electronic device holder rotatably coupled to a bottom side of the rotatable shelf.

9. The aircraft monument of claim 8, further comprising a vertical pocket configured to retain the tray table when the tray table is in a stowed position.

10. The aircraft monument of claim 8, wherein the tray table comprises a main hinge about which the rotatable shelf is configured to rotate with respect to the extendible arm and a secondary hinge about which the electronic device holder is configured to rotate with respect to the rotatable shelf.

11. The aircraft monument of claim 10, wherein each of the main hinge and the secondary hinge is configured to accommodate between 90 degrees and 180 degrees of rotation.

12. The aircraft monument of claim 11, wherein, in response to the extendible arm extending from the aircraft monument, the rotatable shelf is configured to rotate between a horizontal position, a vertical position, and an obtuse position and the electronic device holder is configured to independently rotate between an open position and a closed position.

13. The aircraft monument of claim 12, wherein, in response to the rotatable shelf being in the obtuse position and the electronic device holder being in the open position, the tray table is configured to receive a portable electronic device (PED) such that the PED is resting on the electronic device holder and against the rotatable shelf at an incline.

14. The aircraft monument of claim 8, wherein a bottom side of the rotatable shelf defines a cavity for receiving the electronic device holder.

15. The aircraft monument of claim 14, further comprising a mechanical latch configured to secure the electronic device holder within the cavity such that the electronic device holder is flush with the bottom side of the rotatable shelf.

16. The aircraft monument of claim 14, further comprising a first magnet disposed within the cavity and a second magnet disposed within the electronic device holder, wherein the first magnet and the second magnet are of opposite polarization such that the second magnet is attracted to the first magnet.

17. The aircraft monument of claim 10, wherein the main hinge comprises a friction device configured to resist rotation of the rotatable shelf.

18. An aircraft, comprising:
a wheelchair plinth;
an aircraft monument disposed proximate the wheelchair plinth; and
a tray table extendible from the aircraft monument toward the wheelchair plinth.

19. The aircraft of claim 18, wherein the tray table comprises an extendible arm configured to rotate about a first axis to extend from the aircraft monument, a rotatable shelf coupled to the extendible arm and configured to rotate about a second axis perpendicular to the first axis, and an electronic device holder rotatably coupled to a bottom side of the rotatable shelf.

20. The aircraft of claim 19, wherein the tray table comprises a main hinge about which the rotatable shelf is configured to rotate with respect to the extendible arm and a secondary hinge about which the electronic device holder is configured to rotate with respect to the rotatable shelf, and wherein each of the main hinge and the secondary hinge is configured to accommodate between 90 degrees and 180 degrees of rotation.
